(19) United States
(12) Patent Application Publication
(10) Pub. No.: US 2016/0307222 A1
(43) Pub. Date: Oct. 20, 2016

(54) INFORMATION PROCESSING METHOD, INFORMATION PROCESSING DEVICE, AND COMPUTER-READABLE RECORDING MEDIUM

(71) Applicant: FUJITSU LIMITED, Kawasaki-shi (JP)

(72) Inventors: Takeshi OSOEKAWA, Ohta (JP); Junichi Hirose, Yokohama (JP); Takahisa Ando, Kawasaki (JP); Seishi OKAMOTO, Hachioji (JP)

(73) Assignee: FUJITSU LIMITED, Kawasaki-shi (JP)

(21) Appl. No.: 15/187,040

(22) Filed: Jun. 20, 2016

Related U.S. Application Data
(63) Continuation of application No. PCT/JP2013/085273, filed on Dec. 27, 2013.

(51) Int. Cl. G06Q 30/02

(52) U.S. Cl. CPC G06Q 30/0203; G06Q 30/0201

(57) ABSTRACT

An information processing method includes: dividing processing target data, which indicates an action detected for each of a plurality of persons in a certain period, by a predetermined period length with reference to information related to a time contained in the data and separately performing a principal component analysis in each of the divided period length, by a processor; specifying corresponding axes in temporally adjacent analysis periods based on an axis calculated as a result of each principal component analysis, by the processor; and considering axes associated in the temporally adjacent periods as the same axis throughout all of the processing target data, and grouping the plurality of persons into a plurality of groups, by the processor.

### CROSS-REFERENCE TO RELATED APPLICATION

This application is a continuation application of International Application No. PCT/JP2013/085273, filed on Dec. 27, 2013 and designating the U.S., the entire contents of which are incorporated herein by reference.

### FIELD

The embodiments discussed herein are related to an information processing method and the like.

### BACKGROUND

There is a marketing research which ascertains a purchase tendency of a customer using a customer database created by collecting a purchase history of the customer. In the marketing research, the customers having a similar purchase tendency are grouped and classified into a customer segment in order to ascertain the purchase tendency of the customer. Then, an action in each classified customer segment is analyzed to ascertain the purchase tendency of each customer segment.

For example, the actions of the entire loyal customers are ascertained by analyzing the purchase tendency of the customer segment classified into loyal customers. The loyal customer means a customer recognized as a good customer based on the action such as frequently purchasing a product of a high profit ratio. Then, an increase of the loyal customers is aimed by prompting other customers to take the action of the loyal customer. On the other hand, when a customer segment who has not visited a store as he used to is specified, it is possible to provide a service to a customer who shows a sign not to come to the store. Therefore, it is possible to previously prevent that the customer does not come to the store anymore. In other words, since a pattern of the action of the customers is easily ascertained by grouping the customers, the customers may be motivated for the marketing action.

As a method of grouping the customers, for example, there is a cluster analysis. The cluster analysis is an analysis method of classifying targets by collecting similar ones among different targets so as to create a group. The customer segments are classified in an objective standard using the cluster analysis.

Patent Document 1: Japanese Laid-open Patent Publication No. 2008-152321

However, there is a problem in that the customers are not able to be grouped in consideration of a purchase tendency found only in a certain period.

In a case where the cluster analysis is used, when the customers are grouped, there is a possibility to lose the purchase tendency of a product which is periodically sold in seasons. This is because the cluster analysis is not suitable to the analysis on the purchase tendency in each period such as a quarter or a month.

In a case where the cluster analysis is performed based on purchase history data (history data of the product purchased by the customer) containing a number of products treated in a large store, the number of products treated in the store is overwhelmingly larger than the number of products actually purchased by the customers. Therefore, the majority of the purchase data comes to be data indicating the unsold products. Therefore, in a case where the purchase data is expressed using a vector for each product, the vectors are focused on near the origin indicating that the corresponding product is not sold. As a result, there is a problem in grouping the customers.

### SUMMARY

According to an aspect of the embodiments, an information processing method includes: dividing processing target data, which indicates an action detected for each of a plurality of persons in a certain period, by a predetermined period length with reference to information related to a time contained in the data and separately performing a principal component analysis in each of the divided period length, by a processor; specifying corresponding axes in temporally adjacent analysis periods based on an axis calculated as a result of each principal component analysis, by the processor; and considering axes associated in the temporally adjacent periods as the same axis throughout all of the processing target data, and grouping the plurality of persons into a plurality of groups, by the processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a system configuration of an information processing device according to a first embodiment;

FIG. 2 is a diagram for describing a data structure of purchase history data;

FIG. 3 is a diagram for describing a data structure of purchase data;

FIG. 4 is a diagram for describing a data structure of customer segment data;

FIG. 5 is a diagram for describing a principal component analysis of a purchase history of a customer;

FIG. 6 is a diagram illustrating eigenvectors of the principal components calculated in each period;

FIG. 7 is a diagram illustrating an example in a case where the vectors are rearranged;

FIG. 8 is a diagram for describing an adjustment for the eigenvectors;

FIG. 9 is a diagram for describing a calculation of a height in a direction of the eigenvector;

FIG. 10 is a diagram for describing a process of the information processing device;

FIG. 11 is a diagram illustrating a first example of transition in each period of each class;

FIG. 12 is a diagram illustrating a second example of transition in each period of each class; and

FIG. 13 is a diagram illustrating a hardware configuration of the information processing device.

### DESCRIPTION OF EMBODIMENTS

Preferred embodiments will be explained with reference to accompanying drawings. Further, the scope of rights is not limited by the embodiments.

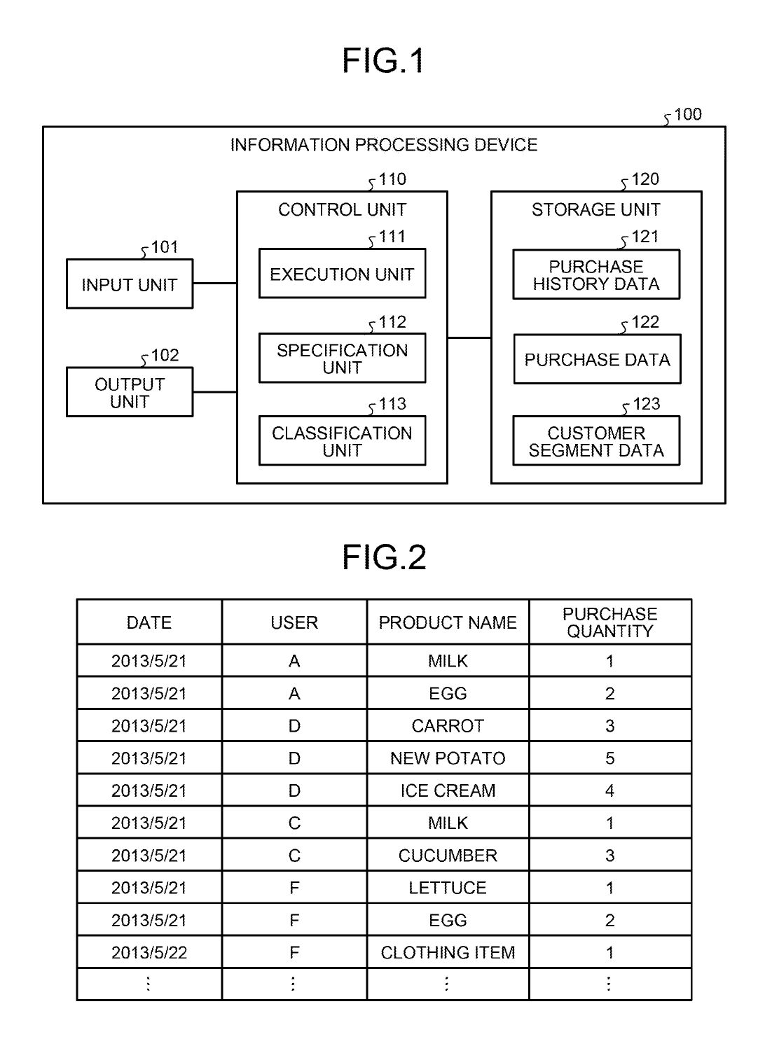

A system configuration of an information processing device 100 will be described using FIG. 1. FIG. 1 is a diagram illustrating an example of the system configuration of the information processing device according to a first embodiment. As illustrated in the example of FIG. 1, the information processing device 100 includes an input unit 101, an output unit 102, a control unit 110, and a storage unit 120. The storage unit 120 contains purchase history data 121, purchase data 122, and customer segment data 123. The storage unit 120 corresponds to, for example, a semiconductor memory element such as a RAM (Random Access Memory), a ROM (Read Only Memory), or a flash memory, or a storage device such as a hard disk or an optical disk.

The data stored in the storage unit 120 will be described. The purchase history data 121 is data storing a purchase history of a product of each customer at each date. A data structure of the purchase history data 121 will be described using FIG. 2. FIG. 2 is a diagram for describing the data structure of the purchase history data. As the example illustrated in FIG. 2, the purchase history data 121 associates a user who purchases a product, a product name of the purchased product, and a purchase quantity at each date. For example, a first record is stored with data that “User A” purchases a (“1”) carton of “Milk” (product name) in “05/21/2013”. In addition, a second record is stored with data that “User A” purchases two (“2”) “Eggs” (product name) in “05/21/2013”. In addition, a third record is stored with data that “User D” purchases three (“3”) “Carrots” (product name) in “05/21/2013”. Further, the purchase history data 121 associates a user who purchases a product, a product name of the purchased product, and a purchase quantity at each date even in other records. Further, the user has the same meaning as the customer as a classification target.

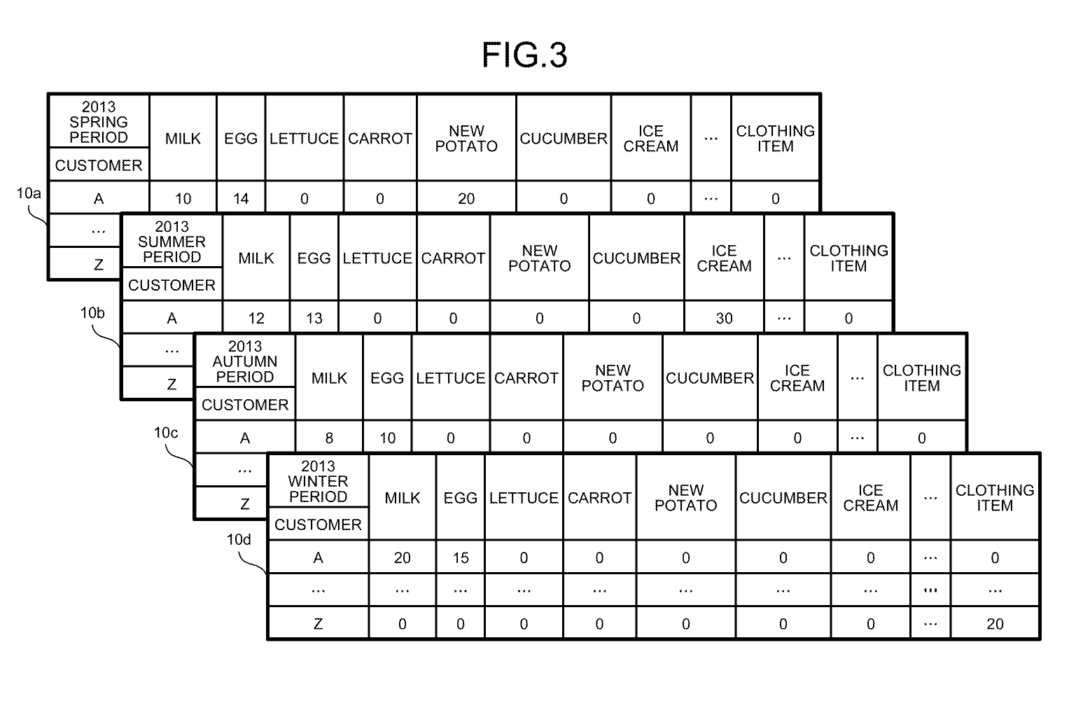

The purchase data 122 is data obtained by counting total purchase quantities of each product in each period with respect to each customer. A data structure of the purchase data 122 will be described using FIG. 3. FIG. 3 is a diagram for describing the data structure of the purchase data 122. As the example illustrated in FIG. 3, the purchase data 122 contains, for example, data 10a of a spring period, data 10b of a summer period, data 10c of an autumn period, and data 10d of a winter period in 2013. In the data 10a to 10d of each period, each of the customers A to Z is associated to a total purchase quantity of each product.

For example, the data 10d of the winter period associates the customer A to the data of purchasing “20” cartons of milk, “15” eggs, “0” lettuces, “0” carrots, “0” new potatoes, “0” cucumbers, “0” ice creams, and “0” clothing items. In addition, the data 10d of the winter period associates the customer Z to the data of purchasing “0” cartons of milk, “0” eggs, “0” lettuces, “0” carrots, “0” new potatoes, “0” cucumbers, “0” ice creams, and “20” clothing items. Further, the data 10d of the winter period associates a total number of purchase quantities to each product even with respect to other users. In addition, the data 10d of the winter period may contain another product to associate a total number of purchase quantities. In addition, the purchase data 122 associates a total number of purchase quantities to each product with respect to each of the respective customers A to Z even in the other periods.

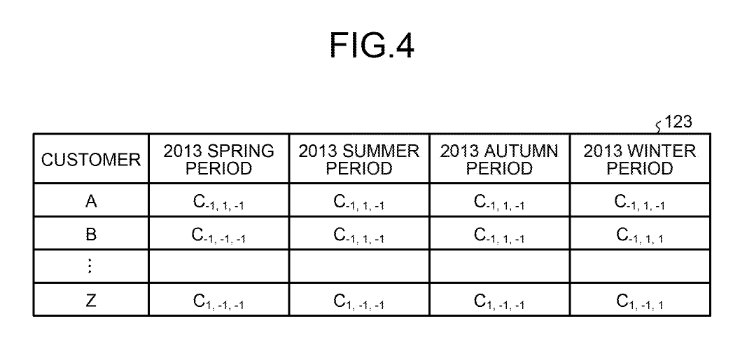

The customer segment data 123 is data used in determining a customer segment. Using FIG. 4, a data structure of the customer segment data 123 will be described. FIG. 4 is a diagram for describing the data structure of the customer segment data 123. As the example illustrated in FIG. 4, the customer segment data 123 associates class data to each period with respect to each customer. The class data is data used in setting a class which is calculated using a class determination function. The class corresponds to a customer segment which is determined by the information processing device 100.

For example, the first record of the customer segment data 123 contains class data “c_{-1,1,-1}” of the spring period in 2013, the class data “c_{-1,1,-1}” of the summer period in 2013, and the class data “c_{-1,1,-1}” of the autumn period in 2013 of the customer A. Furthermore, the first record contains the class data “c_{-1,1,-1}” of the winter period in 2013. In addition, the second record of the customer segment data 123 contains class data “c_{-1,-1,-1}” of the spring period in 2013, the class data “c_{-1,1,-1}” of the summer period in 2013, and the class data “c_{-1,1,-1}” of the autumn period in 2013 of the customer B. Furthermore, the second record contains class data “c_{-1,1,1}” of the winter period in 2013. Further, the customer segment data 123 associates the class data to each period with respect to the other customers.

Next, the respective processors contained in the control unit 110 will be described. The control unit 110 includes an execution unit 111, a specification unit 112, and a classification unit 113. The function of the control unit 110 can be realized by, for example, an integrated circuit such as an ASIC (Application Specific Integrated Circuit) or an FPGA (Field Programmable Gate Array). In addition, the function of the control unit 110 can be realized by, for example, a CPU (Central Processing Unit) which executes a predetermined program.

The execution unit 111 divides processing target data, which indicates an action detected for each of a plurality of persons in a certain period, by a predetermined period length with reference to information related to a time contained in the data. Furthermore, the execution unit 111 separately performs a principal component analysis at every divided period length.

For example, the execution unit 111 performs the following process. First, the execution unit 111 counts a total number of respective purchased products in each period with respect to each customer based on the purchase history data 121 so as to generate the purchase data 122. For example, the purchase history data 121 corresponds to FIG. 2. In addition, the purchase data 122 corresponds to FIG. 3.

The execution unit 111 acquires a vector xk,j of a summarized action of each user in each period based on the generated purchase data 122. A process of acquiring the vector xk,j will be described using FIG. 3. In other words, the execution unit 111 assigns a dimension to each product with respect to the purchase data 122 in a certain period and sets the number of respective purchased products as each dimensional value so as to set one vector xk,j in each period with respect to one user. Therefore, in a case where the purchase data 122 is created in a quarter, the execution unit 111 acquires four vectors xk,j of the spring period, the summer period, the autumn period, and the winter period per one user.

For example, in a case where the vector xk,j is set with respect to the data 10d of the winter period of the customer A, the execution unit 111 sets the purchase quantity “20” cartons of milk as a first dimensional value, and the purchase quantity “15” of egg as a second dimensional value. The execution unit 111 also sets the purchase quantity of each product as each dimensional value with respect to the other dimensions. Then, the execution unit 111 sets the vector xk,j based on each dimensional value.

Further, “k” indicates each user. “k” is set to fall within a range from 1 to n (a total number of users). In addition, “j” indicates the divided period. The period is, for example, the spring period, the summer period, the autumn period, and the winter period in 2013. “j” is set to fall within a range from 1 to t (the final period).

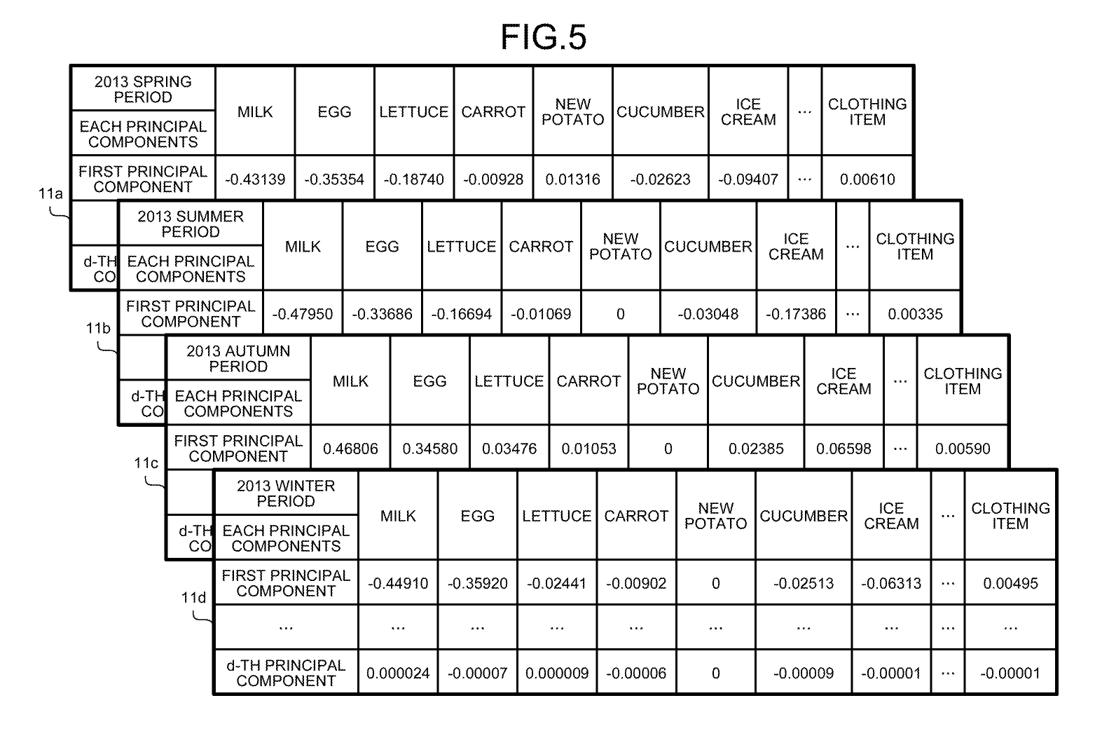

The execution unit 111 performs the principal component analysis on the data of each period of the purchase data 122. In a case where the number of types of products contained in the purchase data 122 is “d”, the execution unit 111 calculates first to d-th principal components. The execution unit 111 assigns each dimension to each product, sets the value of each product to each principal component based on the result of the principal component analysis, and creates principal component data. The principal component data created by the execution unit 111 corresponds to FIG. 5 for example.

The principal component analysis performed on the purchase history of the customer by the execution unit 111 will be described using FIG. 5. FIG. 5 is a diagram for describing the principal component analysis of the purchase history of the customer. First, in a case where the number of types of the products is “d”, the execution unit 111 calculates the first to d-th principal components based on the purchase data 10d of the winter period in 2013. The execution unit 111 generates an eigenvector from each calculated principal component. Next, the execution unit 111 associates each value of each product of each principal component to each product based on the generated eigenvector. Further, in the following, the data subjected to the principal component analysis in each period will be called the principal component data.

For example, the execution unit 111 associates a value “−0.44910” to milk, a value “−0.35920” to egg, a value “−0.02441” to lettuce, a value “−0.00902” to carrot, and a value “0” to new potato in the record of the first principal component in principal component data 11d of the winter period. Furthermore, the execution unit 111 associates a value “−0.02513” to cucumber, a value “−0.06313” to ice cream, and a value “0.00495” to clothing item in the record of the first principal component.

In addition, the execution unit 111 associates a value “−0.000024” to milk, a value “−0.00007” to egg, a value “−0.000009” to lettuce, a value “−0.00006” to carrot, and a value “0” to new potato in the record of the d-th principal component in the principal component data 11d of the winter period. Furthermore, the execution unit 111 associates a value “−0.00009” to cucumber, a value “−0.00001” ice cream, and a value “0.00001” to clothing item in the record of the d-th principal component. Further, the execution unit 111 associates each calculated value of each principal component to each product even other principal components of the winter period in 2013. In addition, the execution unit 111 similarly performs the principal component analysis even in the period other than the winter period in 2013 and creates each piece of principal component data.

The specification unit 112 specifies the corresponding axes in temporally adjacent analysis periods based on the axis calculated as a result of each principal component analysis. For example, the specification unit 112 performs the following process. First, the specification unit 112 enumerates the eigenvectors of the respective principal components generated by the execution unit 111 in each period. Next, the specification unit 112 selects sets of the eigenvectors which are contained in the adjacent periods and have a maximum inner product, and rearranges the eigenvectors in the respective periods to adjacently dispose the selected sets. Therefore, the specification unit 112 rearranges the corresponding eigenvectors to be disposed side by side in the respective columns, and identifies the eigenvectors of each period. In order words, the specification unit 112 selects sets of the eigenvectors which are contained in the adjacent periods and of which the axes are disposed nearly in parallel, and rearranges the eigenvectors of each period to adjacently dispose the selected set.

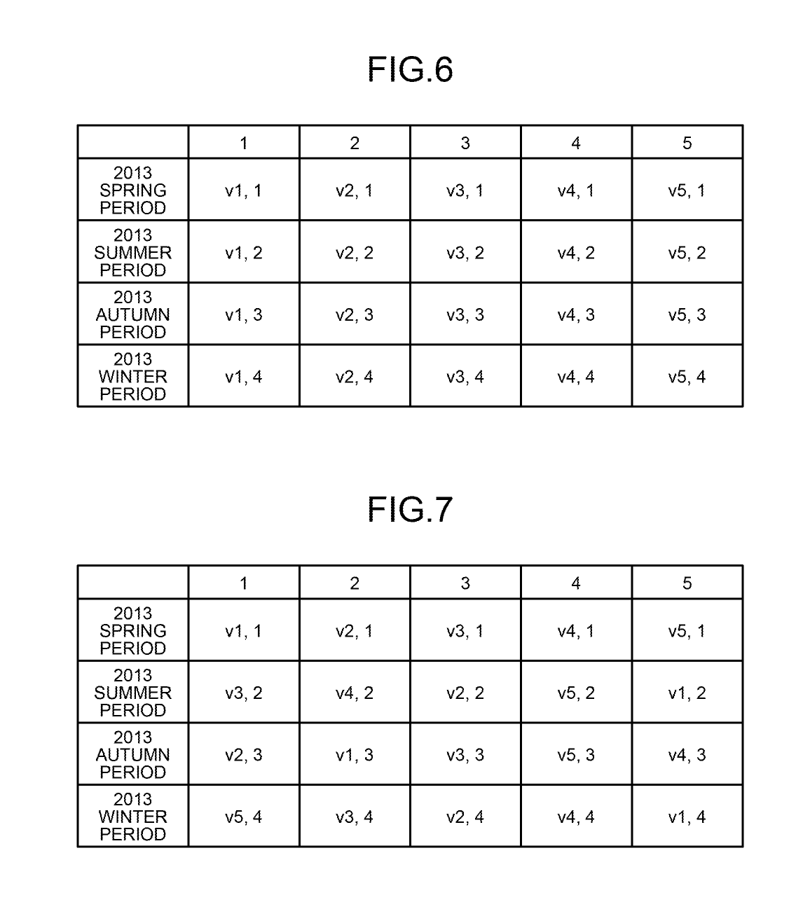

The rearrangement of the eigenvectors of each period performed by the specification unit 112 will be described using FIG. 6. FIG. 6 is a diagram illustrating the eigenvectors of the respective principal components calculated in each period. As the example illustrated in FIG. 6, the specification unit 112 enumerates the eigenvectors in each row from the first principal component to a fifth principal component in the respective periods of the spring period, the summer period, the autumn period, and the winter period in 2013. In each column, the values from 1 to 5 are assigned. In FIG. 6, each eigenvector is expressed in a format of “vi,j” in which “i” represents a principal component, and “j” represents a period.

For example, the first principal component of the spring period in 2013 is expressed as “v1,1”, the second principal component as “v2,1”, the third principal component as “v3,1”, the fourth principal component as “v4,1”, and the fifth principal component as “v5,1”. In addition, the first principal component of the summer period in 2013 is expressed as “v1,2”, the second principal component as “v2,2”, the third principal component as “v3,2”, the fourth principal component as “v4,2”, and the fifth principal component as “v5,2”. Further, the specification unit 112 enumerates the eigenvectors from the first principal component to the fifth principal component even with respect to the eigenvectors in the other periods.

Next, the specification unit 112 selects sets of the eigenvectors which are contained in the adjacent periods and has a maximum inner product, and rearranges the eigenvectors in the respective periods to adjacently dispose the selected set. For example, the specification unit 112 calculates the respective inner products of an eigenvector “v1,1” of the spring period in 2013 with respect to the eigenvectors “v1,2”, “v2,2”, “v3,2”, “v4,2”, and “v5,2” of the summer period in 2013. Next, the specification unit 112 selects the eigenvector “v3,2” of which the inner product value with respect to the eigenvector “v1,1” is maximized. Then, the specification unit 112 rearranges the respective vectors of the summer period in 2013 such that the selected eigenvector “v3,2” comes in the same “first” column as the eigenvector “v1,1”.

Next, the specification unit 112 calculates the respective inner products of an eigenvector “v2,1” of the spring period in 2013 with respect to the eigenvectors “v1,2”, “v2,2”, “v4,2”, and “v5,2” of the summer period in 2013. Next, the specification unit 112 selects the eigenvector “v4,2” of which the inner product value with respect to the eigenvector “v2,1” is maximized. Then, the specification unit 112 rearranges the respective vectors of the summer period in 2013 such that the selected eigenvector “v4,2” comes in the same “second” column as the eigenvector “v2,1”.

Next, the specification unit 112 calculates the respective inner products of an eigenvector “v3,1” of the spring period in 2013 with respect to the eigenvectors “v1,2”, “v2,2”, and “v5,2” of the summer period in 2013. Next, the specification unit 112 selects the eigenvector “v2,2” of which the inner product value with respect to the eigenvector “v3,1” is maximized. Then, the specification unit 112 rearranges the respective vectors of the summer period in 2013 such that the selected eigenvector “v2,2” comes in the same “third” column as the eigenvector “v3,1”.

Next, the specification unit 112 calculates the respective inner products of an eigenvector “v4,1” of the spring period in 2013 with respect to the eigenvectors “v1,2” and “v5,2” of the summer period in 2013. Next, the specification unit 112 selects the eigenvector “v5,2” of which the inner product value with respect to the eigenvector “v4,1” is maximized. Then, the specification unit 112 rearranges the respective eigenvectors of the summer period in 2013 such that the selected eigenvector “v5,2” comes in the same “fourth” column as the eigenvector “v4,1”.

In this way, the specification unit 112 rearranges the respective vectors of the summer period in 2013. An example of the rearranged eigenvectors is illustrated in FIG. 7. FIG. 7 is a diagram illustrating an example in a case where the respective vectors are rearranged. As the example illustrated in FIG. 7, the respective vectors contained in the summer period, the autumn period, and the winter period in 2013 are rearranged. Therefore, the specification unit 112 rearranges the eigenvectors such that the corresponding eigenvectors are disposed side by side in the respective columns in the spring period, the summer period, the autumn period, and the winter period in 2013.

In other words, the specification unit 112 rearranges the eigenvectors to make “vi,j+1” satisfy Equation (1) with respect to the period j={1, . . . , t−1}. Further, “i′” is assumed to contain {i+1, . . . , d}. In addition, “t” represents the final period.

|vi,j·vi′,j+1|≦|vi,j·vi,j+1| (1)

In addition, the specification unit 112 similarly selects sets of the eigenvectors which are contained in the autumn period in 2013 adjacent to the summer period in 2013 and of which the inner product is maximized. The specification unit 112 rearranges the eigenvectors of each period to adjacently dispose the selected sets. Furthermore, the specification unit 112 similarly selects sets of the eigenvectors which are contained in the winter period in 2013 adjacent to the autumn period in 2013 and of which the inner product is maximized. The specification unit 112 rearranges the eigenvectors of each period to adjacently dispose the selected sets.

The classification unit 113 considers the axes associated in the temporally adjacent periods as the same axis throughout all of the processing target data, and groups the plurality of persons into a plurality of groups. For example, the classification unit 113 performs the following process. First, in a case where the inner product of the rearranged eigenvectors in the adjacent periods is negative, the classification unit 113 multiplies “−1” to one of the eigenvectors to adjust the directions of the eigenvectors.

For example, in a case where the inner product between the eigenvector “v4,2” of the summer period in 2013 and the eigenvector “v1,3” of the autumn period in 2013 is negative, the classification unit 113 multiplies “−1” to the eigenvector “v1,3” to be “−v1,3”. In other words, in the case of “vi,j·vi,j+1<0” (here, j={1, . . . , t−1} is period, and i={1, . . . , d} is product), the classification unit 113 adjusts the direction of the eigenvector by setting “vi,j+1” as “−vi,j+1”.

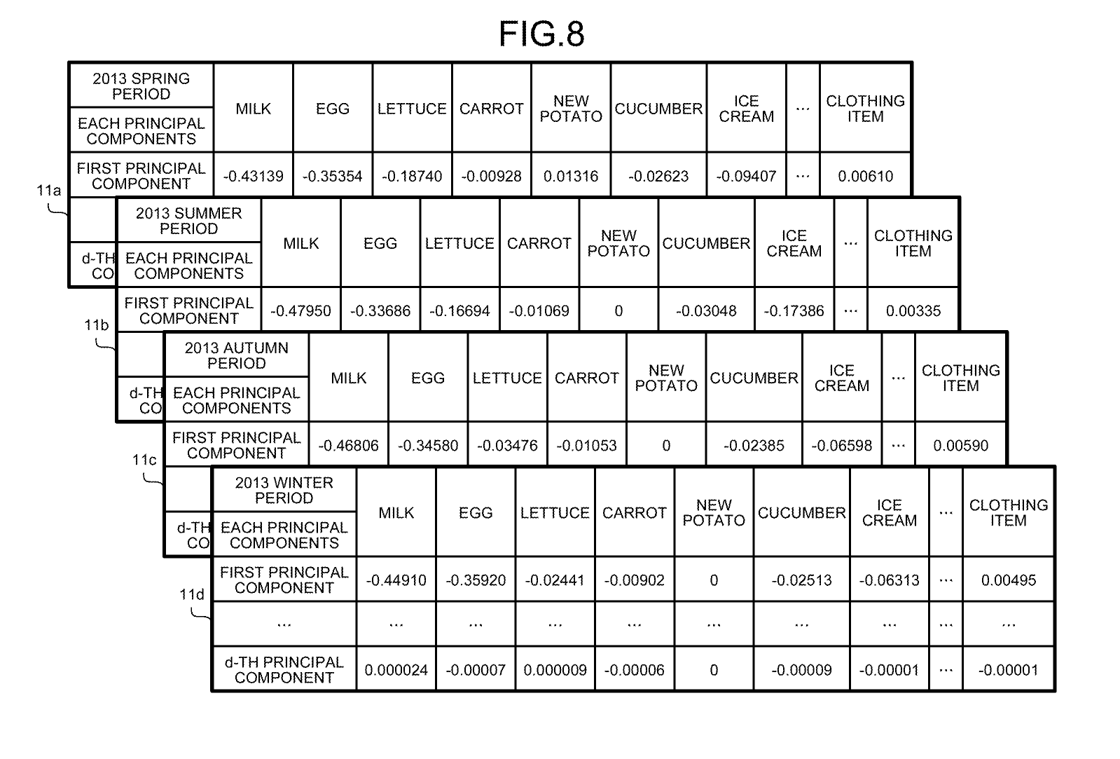

FIG. 8 is a diagram for describing the adjustment in the direction of the eigenvector. As the example illustrated in FIG. 8, principal component data 11a of the spring period in 2013, principal component data 11b of the summer period, principal component data 11c of the autumn period, and the principal component data 11d of the winter period are illustrated. The values of the respective products in a case where the eigenvector “v1,3” is set to “−v1,3” are stored in the record of the first principal component of the principal component data 11c of the autumn period in 2013. In other words, the values of the record of the first principal component of the principal component data 11c illustrated in FIG. 5 are multiplied by “−1”. The record of the first principal component of the principal component data 11c in this case corresponds to the record of the first principal component of the principal component data 11c illustrated in the example of FIG. 8.

Next, the classification unit 113 calculates a height of the eigenvector direction. For example, the classification unit 113 calculates the height of the eigenvector direction by multiplying the vector “xk,j” of the summarized action of each user in each period acquired by the execution unit 111 to the eigenvector “vd,j” adjusted in its direction.

In other words, the classification unit 113 calculates the height of the eigenvector direction by Equation (2).

yk,j=(xk,j·v1,j, . . . , xk,j·vd,j) (2)

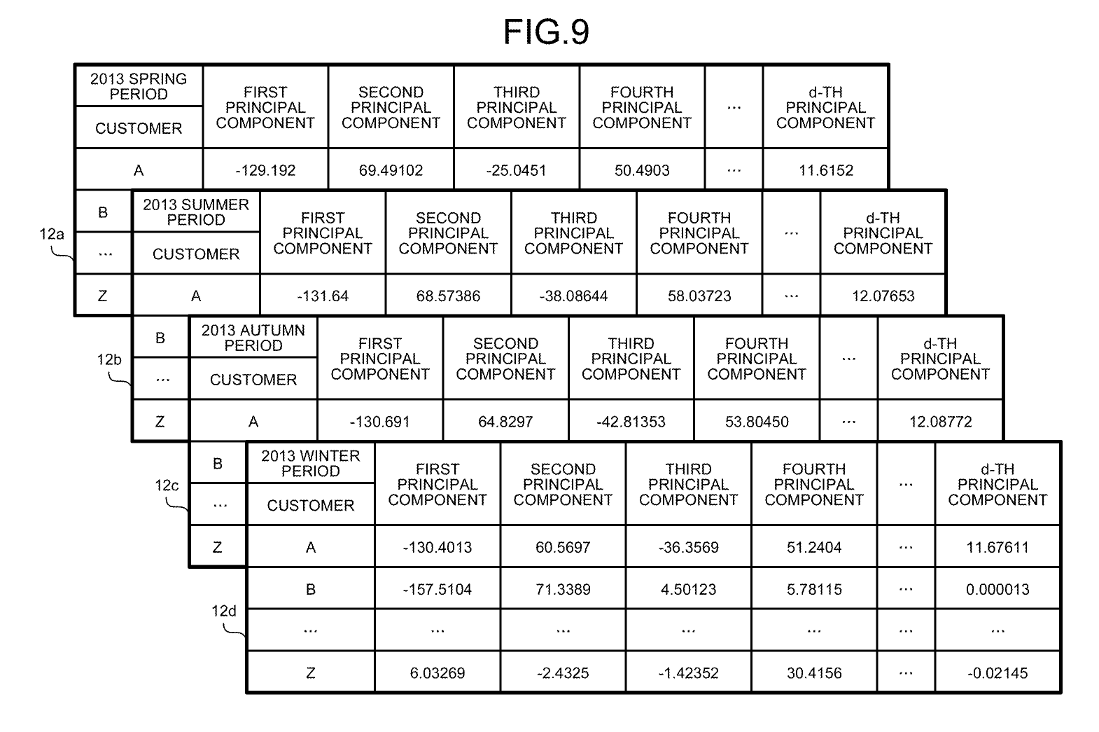

The calculation of the height of the eigenvector direction will be described using FIG. 9. FIG. 9 is a diagram for describing the calculation of the height of the eigenvector direction. As the example illustrated in FIG. 9, height data 12a of the principal component of the spring period, height data 12b of the principal component of the summer period, height data 12c of the principal component of the autumn period, and height data 12d of the principal component of the winter period in 2013 to which the height of the eigenvector direction is reflected are illustrated. In the height data of the principal component of each period, the height of the eigenvector direction is stored in each of the first to d-th principal components.

For example, in principal component data 12d of the winter period in 2013, “−130.4013” is stored in the first principal component of the customer A, “60.5697” in the second principal component, “−36.3569” in the third principal component, “51.2404” in the fourth principal component, and “11.67611” in the d-th principal component. In addition, in the principal component data 12d of the winter period in 2013, “−157.5104” is stored in the first principal component of the customer B, “71.3389” in the second principal component, “4.50123” in the third principal component, “5.78115” in the fourth principal component, and “0.000013” in the d-th principal component.

In addition, in the principal component data 12d of the winter period in 2013, “6.03269” is stored in the first principal component of the customer Z, “−2.4325” in the second principal component, “−1.42352” in the third principal component, “30.4156” in the fourth principal component, and “−0.02145” in the d-th principal component. Further, even with respect to the other customers of the winter period in 2013, the height of the eigenvector direction is stored in each principal component. In addition, even with respect to the other periods (the spring period, the summer period, and the autumn period) in 2013, the height of the eigenvector direction related to each principal component is stored with respect to each customer.

Next, the classification unit 113 determines a class to which each user belongs in each period. The classification unit 113 determines the class to which each user belongs by substituting the calculated height “yk,j” of the eigenvector direction to a class determination function “f(yk,j)”. For example, the class determination function “f(yk,j)” is expressed as Equation (3).

f(yk,j)=1(0<y)

f(yk,j)=0(y=0)

f(yk,j)=−1(y<0) (3)

The class determination function of Equation (3) is an example, and other class determination functions may be used. For example, the classification unit 113 may use the class determination function “f(yk,j)” of the following Equation (4).

f(yk,j)=1(50<y)

f(yk,j)=0(y=50)

f(yk,j)=−1(y<50) (4)

In other words, the classification unit 113 may determine the class of each user based on whether the calculated height of the eigenvector direction with respect to each principal component in each period is larger than 50, equal to 50, or less than 50. Further, the classification unit 113 may use a class determination function other than the above function. Then, the classification unit 113 stores the determined class of each customer in the customer segment data.

FIG. 4 is an example that the classification unit 113 determines the class by substituting the height of the eigenvector direction to the class determination function “f(yk,j)”. The determination of the classification unit 113 on the class to which each user belongs will be described using FIG. 4. As the example illustrated in FIG. 4, the class of the customer A of the spring period in 2013 is “c_{1,1,-1}” based on the customer segment data 123. In addition, the class of the customer A of the summer period in 2013 is “c_{-1,1,-1}”. In addition, the class of the customer A of the autumn period in 2013 is “c_{-1,1,-1}”. In addition, the class of the customer A of the winter period in 2013 is “c_{-1,1,-1}”.

Further, in the above-described example, the classification unit 113 substitutes the heights of the eigenvector directions corresponding to the first to third principal components to the class determination function “f(yk,j)”. The classification unit 113 may select the heights of the eigenvector directions corresponding to the principal components other than the first to third principal components.

On the other hand, the class of the customer B of the spring period in 2013 is “c_{-1,-1,-1}”. In addition, the class of the customer B of the summer period in 2013 is “c_{-1,1,-1}”. In addition, the class of the customer B of the autumn period in 2013 is “c_{-1,1,-1}”. In addition, the class of the customer B of the winter period in 2013 is “c_{-1,1,1}”.

For example, the classification unit 113 determines that the class of the customer A is “c_{-1,1,-1}” throughout the spring period, the summer period, the autumn period, and the winter period. In addition, the classification unit 113 determines that the customer B belongs to the class “c_{-1,-1,-1}” different from that of the customer A in the spring period but belongs to the same class “c_{-1,1,-1}” as that of the customer A in the summer and autumn periods. In addition, the classification unit 113 determines that the customer B belongs to the class “c_{-1,1,1}” different from that of the customer A in the winter period. Further, the classification unit 113 may determine the belonging class even with respect to the other customers.

Further, the classification unit 113 may increase or decrease the number of heights of the eigenvector directions to be substituted to the class determination function. For example, in a case where the number of heights of the eigenvector directions to be substituted to the class determination function is set to “4” by the classification unit 113, the class is expressed as “c_{-1,1,-1,-1}” for example. In addition, in a case where the number of heights of the eigenvector directions is set to “2” by the classification unit 113, the class is expressed as “c_{-1,1}” for example.

In addition, the classification unit 113 may set the number of classes to be classified according to a total number of customers and an object of classifying the customers. For example, in a case where the number of heights of the eigenvector directions to be substituted to the class determination function is set to “3” by the classification unit 113, the class determination function has three return values. Therefore, the classes are classified into “27” types at a maximum. In addition, in a case where the number of heights of the eigenvector directions to be substituted to the class determination function is set to “4” by the classification unit 113, the classes are classified into “81” types at a maximum. In addition, in a case where the number of heights of the eigenvector directions to be substituted to the class determination function is set to “2” by the classification unit 113, the classes are classified into “9” types at a maximum.

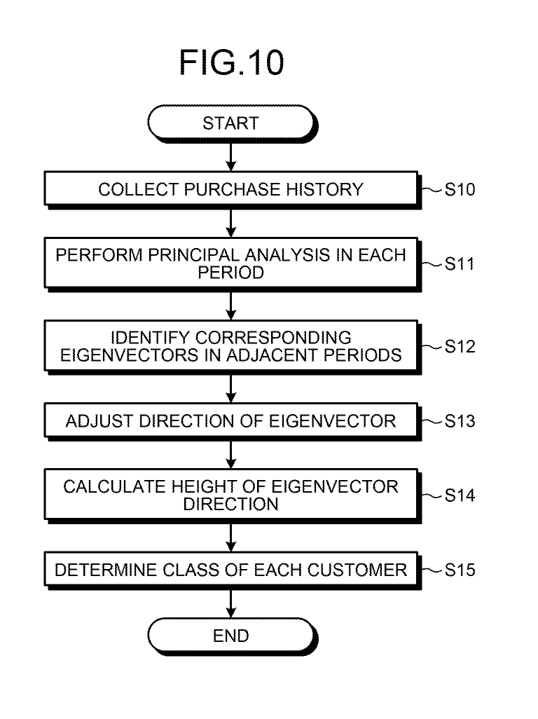

A processing flow of the information processing device will be described using FIG. 10. FIG. 10 is a diagram for describing the processing of the information processing device. First, the execution unit 111 counts a total number of respective purchased products in each period with respect to each customer based on the purchase history data 121 (Step S10). The execution unit 111 summarizes the counted result to generate the purchase data 122. In addition, the execution unit 111 acquires the vector “xk,j” of the summarized action of each user in each period based on the generated purchase data 122.

Next, the execution unit 111 performs the principal component analysis in each divided period (Step S11). For example, in a case where the number of product types is “d”, the execution unit 111 calculates the first to d-th principal components in each period. The execution unit 111 generates the eigenvectors corresponding to the calculated first to d-th principal components. Then, the execution unit 111 creates the principal component data which is obtained by associating the value of each product to each principal component in each period.

The specification unit 112 identifies the corresponding eigenvectors in the adjacent periods (Step S12). For example, the specification unit 112 enumerates the eigenvectors of the respective principal components generated by the execution unit 111 in each period. Next, the specification unit 112 selects sets of the eigenvectors which are contained in the adjacent periods and have a maximum inner product, and rearranges the eigenvectors in the respective periods to adjacently dispose the selected sets. Therefore, the specification unit 112 rearranges the corresponding eigenvectors to be disposed side by side in the respective columns.

The classification unit 113 adjusts the direction of the eigenvector (Step S13). In other words, in a case where the inner product of the rearranged eigenvectors in the adjacent periods is negative, the classification unit 113 multiplies “−1” to one of the eigenvectors to adjust the directions of the eigenvectors.

The classification unit 113 calculates the height of the eigenvector direction (Step S14). In other words, the classification unit 113 calculates the height by multiplying the vector “xk,j” of the summarized action of each user acquired by the execution unit 111 and the eigenvector “vd,j”.

The classification unit 113 determines the class of each customer in each period (Step S15). In other words, the classification unit 113 determines the class to which each user belongs by substituting the calculated height “yk,j” of the calculated eigenvector direction to a class determination function “f(yk,j)”. Further, regarding the height to be substituted to the class determination function, the classification unit 113 may select the height of the eigenvector direction corresponding to a certain principal component.

In other words, the information processing device 100 includes the following processors. The information processing device 100 includes the execution unit 111 which divides the processing target data indicating the action detected for each of the plurality of persons in a certain period by a predetermined period length with reference to the information related to a time contained in the data, and separately performs the principal component analysis in each divided period length. The information processing device 100 includes the specification unit 112 which specifies the corresponding axes in the temporally adjacent analysis periods based on the axis calculated as a result of each principal component analysis. The information processing device 100 includes the classification unit 113 which considers the axes associated in the temporally adjacent periods as the same axis throughout all of the processing target data, and groups the plurality of persons into a plurality of groups. With this configuration, the information processing device 100 can group the customers in consideration of a purchase tendency found only in a certain period.

In addition, the specification unit 112 specifies the corresponding vectors by associating the vectors having a large inner product value among the temporally adjacent vectors. Therefore, it is possible to specify a set of vectors which are disposed nearly in parallel in the adjacent periods.

In addition, in a case where the inner product value of the temporally adjacent vectors is negative, the classification unit 113 inverses the direction of one of the vectors. Therefore, it is possible to adjust the directions of the vectors in the adjacent periods.

In addition, the classification unit 113 groups the plurality of persons into a plurality of groups based on the height of each vector direction. Therefore, it is possible to classify the plurality of persons into the respective groups in consideration of the height of each vector direction.

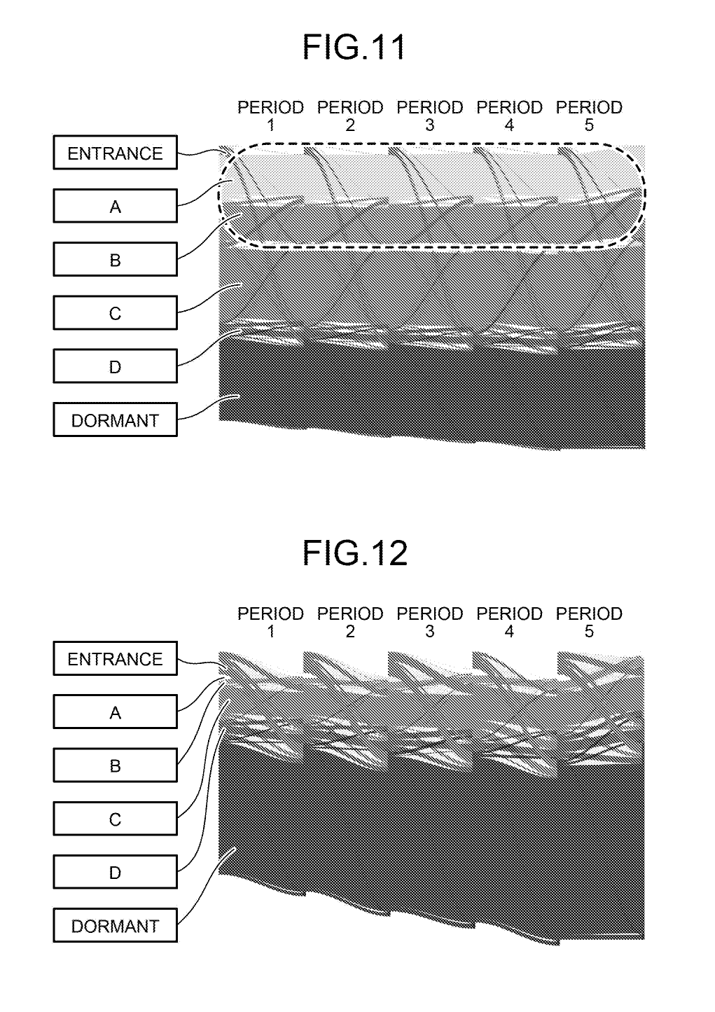

Next, the transition of each class will be described using FIG. 11. FIG. 11 is a diagram illustrating a first example of the transition in each period of each class. As the example illustrated in FIG. 11, the classes are classified into six classes of “Entrance”, “A”, “B”, “C”, “D”, and “Dormant”. The “Entrance” class is a class of the customers whose entrance time is latest. Each of the “A”, “B”, “C”, and “D” classes are a class of the customers, which is determined by the classification unit 113 based on the class determination function. The “Dormant” class is a class of the customers whose purchase history is not updated for a predetermined period. A transition amount of the customer between the adjacent periods is displayed by a band region linking the adjacent periods.

Further, as described above, the determination on all the classes is not limited to the determination based on the class determination function, but the information processing device 100 may determine the classes based on other criteria. For example, the information processing device 100 may determine the class of each user by setting a different condition for each user such as the class of the customers whose entrance time is latest or the class of the customers whose purchase history is not updated for a predetermined period.

The output unit 102 displays the transition amount of the customer between the adjacent periods using the band region linking the adjacent periods. The “A” class and the “B” class indicated by the dotted line are the groups of loyal customers. In the example illustrated in FIG. 11, the transition amounts of the “A” class and the “B” class are small compared to the other classes. Therefore, it can be seen from FIG. 11 that the loyal customers are large and thus the state is stable.

The transition of each class will be described using FIG. 12. FIG. 12 is a diagram illustrating a second example of the transition in each period of each class. The “A” class is a class of the customers who purchase a product for infant. As the example illustrated in FIG. 12, the “A” class does not move to the dormant class. Therefore, it can be seen from FIG. 12 that the customers who purchase the product for infant do not tend to be dormant. On the other hand, it can be also seen from FIG. 12 that about the half of the customers of the “Entrance” class tends to transition to the “Dormant” class.

In other words, the information processing device 100 can capture the outflow and inflow of the customers in each class using a common class label throughout the entire period, and can make handling in sensitivity (for example, a plan for a specific class).

As described above, since the information processing device 100 sets the eigenvector in a direction most emphasizing the purchase tendency, it is possible to alleviate sparseness of samples without losing the entire purchase tendency. For example, in a cluster analysis, it is considered that the dimensions are arranged using a product classification in place of the product. However, in a case where the classification is different from a user's feeling, there is a possibility to lose the feature of the purchase tendency. On the other hand, since the information processing device 100 ascertains the purchase tendency of each customer through the principal component analysis, it is possible to prevent that the feature of entire purchase tendency is lost.

In addition, the information processing device 100 may calculate a factor load amount for each product based on the eigenvector obtained through the principal component analysis on the purchase data 122. The factor load amount is an index indicating a degree of influence of the purchase quantity of each product onto the principal component. Then, the information processing device 100 can easily specify a product having a strong influence on each principal component by representing the calculated factor load amount for each product, and analyze a preference for each class.

In addition, since the information processing device 100 can naturally reflect an influence of a seasonal product by performing the principal component analysis in each period. For example, even in a case where there is a seasonal product more purchased only in the summer period and the seasonal product has much influence on the principal component data of the summer period, the information processing device 100 can group the customers in consideration of the purchase of the seasonal product. Therefore, the information processing device 100 can use the purchase tendency found only in a certain period when the class of each customer is determined.

In addition, the information processing device 100 can catch seasonableness and trend of the product by comparing the factor load amounts of the product in each period, and can also make a plan. For example, the information processing device 100 can ascertain a product of which the factor load amount becomes large only in a certain season by comparing the factor load amount of each product over consecutive periods. Therefore, the seasonal product can be easily detected among a number of products contained in the purchase data 122.

On the other hand, the information processing device 100 can group the customers while reducing the influence of season change by grouping the customers while avoiding the purchase tendency of the product of which the factor load amount becomes only in a certain season.

In addition, the information processing device 100 can ascertain a product which is gradually increased or decreased in the factor load amount by comparing the factor load amounts of each product over consecutive periods. Therefore, it is possible to ascertain a change in the number of purchased products as a trend.

Hereinafter, a modification in the above-described embodiment will be described. In addition to the below modification, variations in design can be appropriately made within a scope not departing from the spirit of the invention.

In the first embodiment, the classification unit 113 has been described such that the heights of the eigenvector directions of the first to third principal components are substituted to the class determination function “f(yk,j)”, but the invention is not limited thereto. For example, the classification unit 113 may select the principal component other than the first to third principal components.

In the first embodiment, the information processing device 100 has been described such that the purchase history data 121 of the spring period, the summer period, the autumn period, and the winter period in 2013 is used, but the invention is not limited thereto. For example, the purchase history data 121 may use the purchase history data in other years.

In the first embodiment, the information processing device 100 has been described such that four quarters of the spring period, the summer period, the autumn period, and the winter period in 2013 are set to perform each process in each period, but the invention is not limited thereto. For example, the information processing device 100 may perform each process at every month.

In the first embodiment, the information processing device 100 has been described such that all the classes are determined based on the class determination function, but the invention is not limited thereto. For example, the information processing device 100 may determine the class of each user by setting a different condition for each user such as the class of the customer whose entrance time is latest or the class of the customer whose purchase history is not updated for a predetermined period.

The above-described information processing device 100 may be mounted in one computer, or may be mounted in a cloud containing a plurality of computers. For example, the information processing device 100 may be configured such that a plurality of computers contained in a cloud system perform the same functions of the execution unit 111, the specification unit 112, and the classification unit 113 illustrated in FIG. 1.

In addition, the process sequence, the control sequence, the specific names, and the information containing various types of data and parameters described in the first embodiment may be arbitrarily changed if not otherwise specified.

Hardware Configuration of Information Processing Device

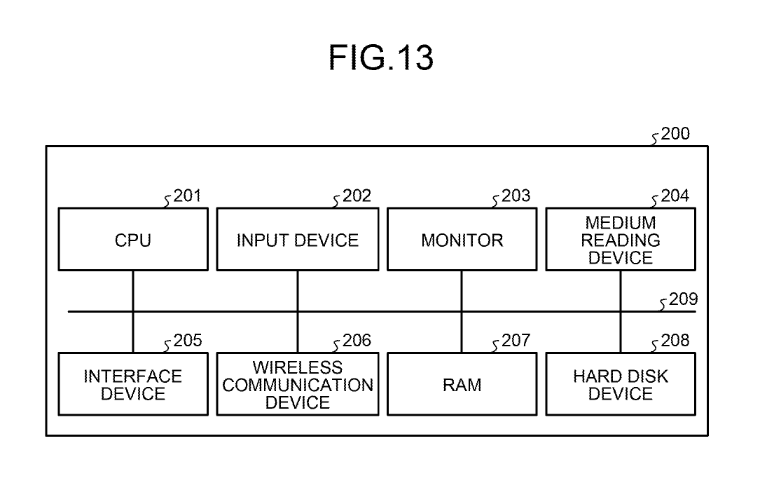

FIG. 13 is a diagram illustrating a hardware configuration of the information processing device. As illustrated in FIG. 13, a computer 200 includes a CPU 201 which performs various types of calculation processes, an input device 202 which receives a data input from the user, and a monitor 203. In addition, the computer 200 includes a medium reading device 204 which reads a program from a storage medium, an interface device 205 which connects the other devices, and a wireless communication device 206 which wirelessly connects the other devices. In addition, the computer 200 includes a RAM (Random Access Memory) 207 which temporarily stores various types of information and a hard disk device 208. In addition, the respective devices 201 to 208 are connected to each other through a bus 209.

The hard disk device 208 stores, for example, an information processing program therein which has the same functions as those the execution unit 111, the specification unit 112, and the classification unit 113 of the control unit 110 illustrated in FIG. 1. In addition, the hard disk device 208 stores various types of data therein used to realize the information processing program.

The CPU 201 reads each program stored in the hard disk device 208, and develops and executes the program in the RAM 207 so as to perform various types of processes. These programs can cause the computer 200 to function as the execution unit 111, the specification unit 112, and the classification unit 113 of the control unit 110 illustrated in FIG. 1.

Further, the above-described information processing program is not necessarily stored in the hard disk device 208. For example, the program stored in a storage medium which can be read by the computer 200 may be read out and executed by the computer 200. Example of the readable storage medium of the computer 200 include a portable storage medium such as a CD-ROM, a DVD disk, and a USB (Universal Serial Bus) memory, a semiconductor memory such as a flash memory, and a hard disk drive. In addition, the program may be stored in a device which is connected to a public line, the Internet, or a LAN (Local Area Network), and then read out and executed by the computer 200.

According to an embodiment of the invention, the customers can be effectively grouped in consideration of the purchase tendency found only in a certain period.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing method comprising:
dividing processing target data, which indicates an action detected for each of a plurality of persons in a certain period, by a predetermined period length with reference to information related to a time contained in the data and separately performing a principal component analysis in each of the divided period length, by a processor;
specifying corresponding axes in temporally adjacent analysis periods based on an axis calculated as a result of each principal component analysis, by the processor; and
considering axes associated in the temporally adjacent periods as the same axis throughout all of the processing target data, and grouping the plurality of persons into a plurality of groups, by the processor.

2. The information processing method according to claim 1, wherein, in the specifying of the axis, corresponding vectors are specified by associating vectors having a large inner product value among vectors which are temporally adjacent, by the processor.

3. The information processing method according to claim 1, wherein, in the grouping, in a case where an inner product value of vectors which are temporally adjacent is negative, a direction of one of the vectors is inversed, by the processor.

4. The information processing method according to claim 1, wherein, in the grouping, the plurality of persons are grouped into the plurality of groups based on a height of each vector direction, by the processor.

5. The information processing method according to claim 1, further including, when a change occurs in the groups, outputting, to a bar graph in which a bar is piled up for each group in the predetermined period length, a band which links the groups before and after the change with a width according to the number of persons who are changed in the groups in the temporally adjacent periods, by the processor.

6. A non-transitory computer-readable recording medium storing an information processing program that causes a computer to execute a process comprising:
dividing processing target data, which indicates an action detected for each of a plurality of persons in a certain period, by a predetermined period length with reference to information related to a time contained in the data and separately performing a principal component analysis in each of the divided period length;
specifying corresponding axes in temporally adjacent analysis periods based on an axis calculated as a result of each principal component analysis; and
considering axes associated in the temporally adjacent periods as the same axis throughout all of the processing target data, and grouping the plurality of persons into a plurality of groups.

7. The non-transitory computer-readable recording medium according to claim 6, wherein, in the specifying of the axis, corresponding vectors are specified by associating vectors having a large inner product value among vectors which are temporally adjacent.

8. The non-transitory computer-readable recording medium according to claim 6, wherein, in the grouping, in a case where an inner product value of vectors which are temporally adjacent is negative, a direction of one of the vectors is inversed.

9. The non-transitory computer-readable recording medium according to claim 6, wherein, in the grouping, the plurality of persons are grouped into the plurality of groups based on a height of each vector direction.

10. The non-transitory computer-readable recording medium according to claim 6, wherein the process further includes, when a change occurs in the groups, outputting, to a bar graph in which a bar is piled up for each group in the predetermined period length, a band which links the groups before and after the change with a width according to the number of persons who are changed in the groups in the temporally adjacent periods.

11. An information processing device comprising:
a processor that executes a process including:
dividing processing target data, which indicates an action detected for each of a plurality of persons in a certain period, by a predetermined period length with reference to information related to a time contained in the data and separately performing a principal component analysis in each of the divided period length;
specifying corresponding axes in temporally adjacent analysis periods based on an axis calculated as a result of each principal component analysis; and
considering axes associated in the temporally adjacent periods as the same axis throughout all of the processing target data, and grouping the plurality of persons into a plurality of groups.

12. The information processing device according to claim 11, wherein the specifying includes specifying corresponding vectors by associating vectors having a large inner product value among vectors which are temporally adjacent.

13. The information processing device according to claim 11, wherein, in a case where an inner product value of vectors which are temporally adjacent is negative, the considering includes inversing a direction of one of the vectors.

14. The information processing device according to claim 11, wherein the considering includes grouping the plurality of persons into the plurality of groups based on a height of each vector direction.

15. The information processing device according to claim 11, wherein the process further includes, when a change occurs in the groups, outputting, to a bar graph in which a bar is piled up for each group in the predetermined period length, a band which links the groups before and after the change with a width according to the number of persons who are changed in the groups in the temporally adjacent periods.
